(19) United States
(12) Patent Application Publication
(10) Pub. No.: US 2025/0379287 A1
(43) Pub. Date: Dec. 11, 2025

(54) BATTERY THERMAL MANAGEMENT MODULE FOR WORK MACHINE

(71) Applicant: Caterpillar Inc., Peoria, IL (US)

(72) Inventors: Baba Sharat Chandra Lingozi, Oro Valley, AZ (US); Dhanasekar Murugan, Peoria, IL (US); Jayneel H. Pandya, Oro Valley, AZ (US)

(73) Assignee: Caterpillar Inc., Peoria, IL (US)

(21) Appl. No.: 18/737,968

(22) Filed: Jun. 8, 2024

(51) Int. Cl. H01M 10/6569; B60R 16/033; B60R 16/04; H01M 10/613; H01M 10/625

(52) U.S. Cl. CPC H01M 10/6569; B60R 16/033; B60R 16/04; H01M 10/613; H01M 10/625; H01M 2220/20

(57) ABSTRACT

A battery thermal management module for a work machine includes a housing. The housing includes a first side wall, a second side wall disposed opposite the first side wall along a first axis, a top wall extending along the first axis and connecting the first side wall with the second side wall, and a bottom wall disposed opposite the top wall and connecting the first side wall with the second side wall. The battery thermal management module is adapted to be removably coupled with the work machine, proximal to a front end of the work machine, via at least one of the first side wall, the second side wall, the top wall, and the bottom wall of the housing. The battery thermal management module also includes a cooling assembly disposed within the housing and adapted to supply a coolant to a battery system associated with the work machine.

### TECHNICAL FIELD

The present disclosure relates to a battery thermal management module for a work machine.

### BACKGROUND

Battery systems are used in a variety of applications as a means of power supply. For example, battery systems are being increasingly implemented in passenger vehicles, energy storage systems, and the like, to provide power supply. Such battery systems are also used to provide operational power to different types of work machines. In order to perform efficiently and ensure longevity, battery modules of the battery systems may have to be maintained and operated within predefined temperature limits to prevent overheating of the battery modules. Thus, all battery systems have a cooling system that supplies a cooling fluid to maintain a temperature of the battery system within predefined temperature limits.

The cooling system includes multiple components that are used to supply the cooling fluid to the battery system. In some cases, as a size of the battery system increases, a size of the cooling system may also increase in order to provide sufficient coolant flow to the battery system. As conventional cooling systems have a bulky design, it is challenging to mount such conventional cooling systems in an available space on the work machine, without affecting an arrangement of other components of the work machine. In some examples, the cooling system may be disposed within a framework of the work machine, which may increase time and efforts required to access, service, and/or replace one or more components of the cooling system.

U.S. Publication Number 2023/0253646 describes a battery module that includes: a plurality of cells positioned in a plurality of rows enclosed within a casing, each of the plurality of cells includes at least a first plurality of cells and a second plurality of cells; and a thermal barrier assembly encapsulating the plurality of cells in the plurality of for thermal management of the plurality of cells. The thermal barrier assembly includes: at least one partition structure in thermal contact along a length of at least one row of the plurality of rows for extracting heat from the first plurality of cells, and at least one heat dissipating structure positioned proximal to at least one end of the at least one partition structure and thermally coupled with the at least one partition structure for dissipating the extracted heat away from the plurality of cells in the plurality of rows.

### SUMMARY OF THE DISCLOSURE

In an aspect of the present disclosure, a battery thermal management module for a work machine is provided. The battery thermal management module includes a housing including a first side wall, a second side wall disposed opposite the first side wall along a first axis, a top wall extending along the first axis and connecting the first side wall with the second side wall, and a bottom wall disposed opposite the top wall and connecting the first side wall with the second side wall. The battery thermal management module is adapted to be removably coupled with the work machine, proximal to a front end of the work machine, via at least one of the first side wall, the second side wall, the top wall, and the bottom wall of the housing. The battery thermal management module also includes a cooling assembly disposed within the housing. The cooling assembly is adapted to supply a coolant to a battery system associated with the work machine.

In another aspect of the present disclosure, a battery thermal management module for a work machine is provided. The battery thermal management module includes a housing including a plurality of walls. The plurality of walls define a first section, a second section, and a third section of the housing. The battery thermal management module is adapted to be removably coupled with the work machine via the housing. The battery thermal management module also includes a cooling assembly disposed within the housing. The cooling assembly is adapted to supply a coolant to a battery system associated with the work machine. The cooling assembly includes a first condenser module disposed in the first section of the housing. The cooling assembly also includes a second condenser module disposed in the second section of the housing. The cooling assembly further includes at least one chiller module disposed in the third section of the housing.

Other features and aspects of this disclosure will be apparent from the following description and the accompanying drawings.

### BRIEF DESCRIPTION OF THE DRAWINGS

FIG. 1 is a schematic perspective view of an exemplary work machine;

FIG. 2 is a schematic front perspective view illustrating a number of battery thermal management modules coupled with the work machine of FIG. 1, according to an example of the present disclosure;

FIG. 3 is a schematic front perspective view of a housing of the battery thermal management modules of FIG. 2;

FIG. 4 is a schematic rear perspective view of the number of battery thermal management modules of FIG. 2;

FIG. 5 is a schematic rear perspective view of a single battery thermal management module;

FIG. 6 is a schematic front perspective view illustrating chiller modules associated with the battery thermal management module of FIG. 5; and

FIG. 7 is a schematic front perspective view of the battery thermal management module of FIGS. 5 and 6.

### DETAILED DESCRIPTION

Wherever possible, the same reference numbers will be used throughout the drawings to refer to the same or like parts.

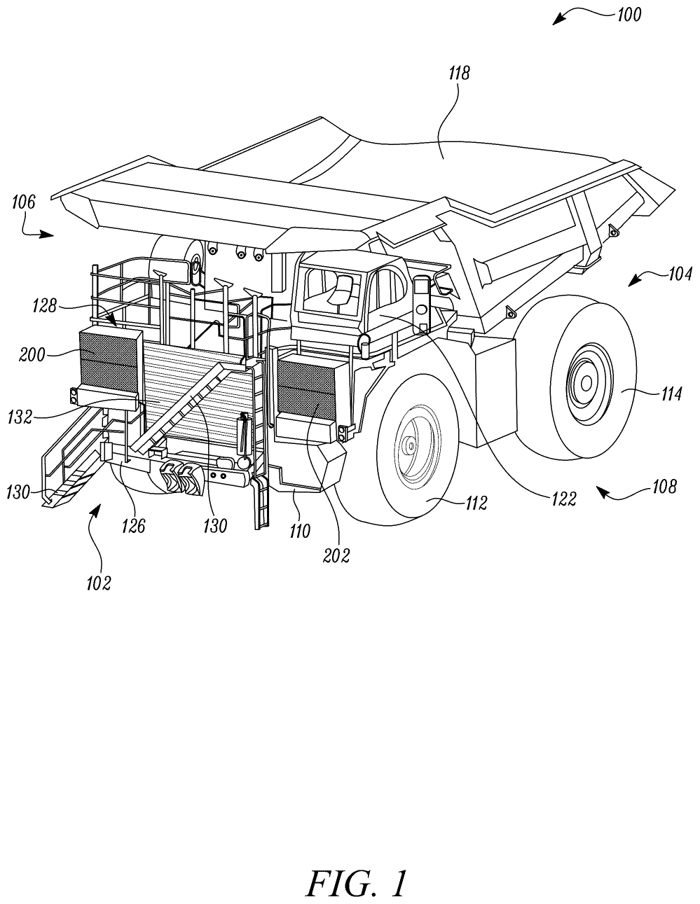

Referring to FIG. 1, a schematic side view of a work machine 100 is illustrated. The work machine 100 defines a front end 102 and a rear end 104 opposite the front end 102. The work machine 100 also defines a first side 106 and a second side 108 opposite the first side 106. The first side 106 is a left side of the work machine 100 and the second side 108 is a right side of the work machine 100. The work machine 100 is embodied as a mining truck that may be used to move payload, such as, asphalt, debris, dirt, snow, feed, gravel, logs, raw minerals, recycled material, rock, sand, woodchips, etc. from one location to another location. Alternatively, the work machine 100 may be a hydraulic excavator, a a dump truck, a dozer, a wheel loader, a track-type tractor, a motor grader, etc. that may be used for various purposes, such as, transportation, digging, construction, landscaping, and the like in various industries.

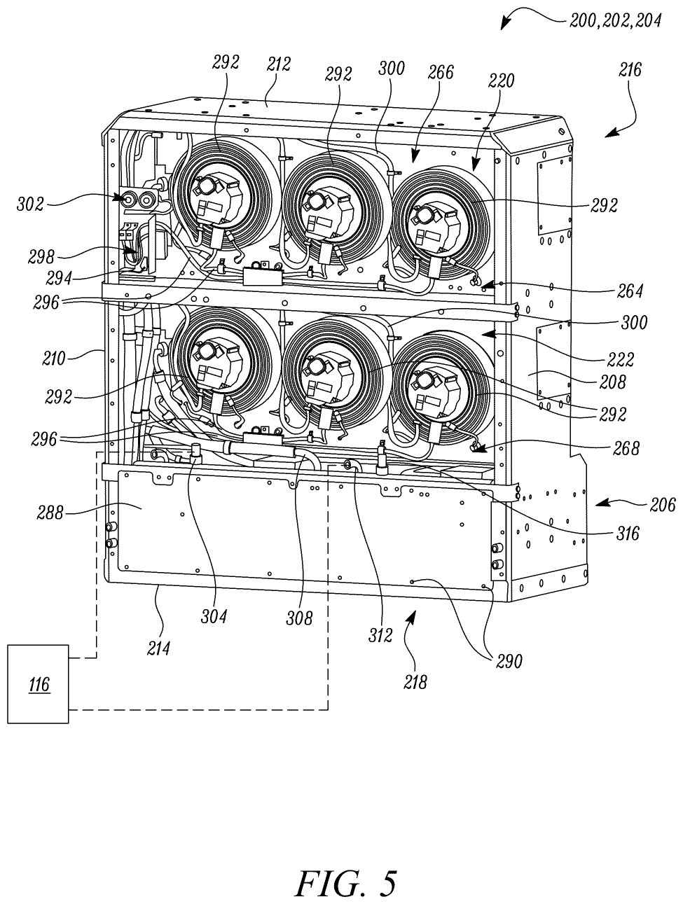

The work machine 100 includes a chassis 110. The chassis 110 supports a pair of front wheels 112 and a pair of rear wheels 114 of the work machine 100. The work machine 100 also includes a battery system 116 (shown in FIG. 5) supported by the chassis 110. The battery system 116 provides power to various components of the work machine 100 for operational and mobility requirements. The battery system 116 provides a supply of electrical power to various components of the work machine 100. In some examples, a combination of the battery system 116 and an engine/a fuel system may be employed to provide power to the work machine 100.

The battery system 116 includes a number of battery modules (not shown) electrically coupled with each other. For example, multiple battery modules may be electrically coupled with one another to provide a desired power output and voltage output. Each battery module includes a number of battery cells. The number of battery cells may incorporate, for example, a lithium-ion battery technology to store electrical power and distribute the stored electrical power at a desired system voltage and a desired system amperage. In other examples, the battery modules may embody any other type of battery technology, as per requirements. Further, the battery cells may include any capacity, voltage, energy, etc.

The work machine 100 further includes a dump body 118 to hold the payload therein. The work machine 100 also includes an operator cabin 122 mounted to the chassis 110. The operator cabin 122 may include one or more controls (not shown) that may enable an operator to control the work machine 100. The operator may be seated within the operator cabin 122 to perform work operations.

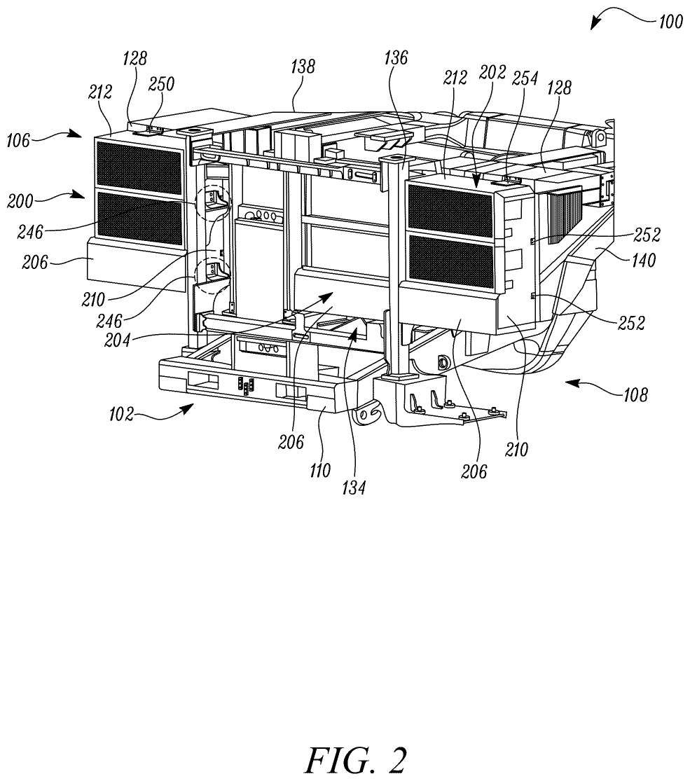

The work machine 100 includes an operator platform 128 and a deck 126. The operator may stand at the operator platform 128 to view ongoing work operations. Each of the operator platform 128 and the deck 126 are supported by the chassis 110 and a trolley structure 136 (shown in FIG. 2) of the work machine 100.

The work machine 100 further includes a number of ladders 130 that may allow the operator to access the operator platform 128. The work machine 100 further includes a grille 132 disposed at the front end 102 of the work machine 100. The grille 132 allows circulation of ambient air into an enclosure 134 (shown in FIG. 2) defined by the chassis 110 and the trolley structure 136 of the work machine 100.

Referring now to FIG. 2, the work machine 100 further includes the trolley structure 136. Various components of the work machine 100 are supported on the trolley structure 136. The trolley structure 136 is coupled with the chassis 110. The work machine 100 further includes a first fender 138 disposed at the first side 106 of the work machine 100 and a second fender 140 disposed at the second side 108 of the work machine 100.

As shown in FIG. 2, the present disclosure relates to a battery thermal management module 200, 202, 204 for the work machine 100. The battery thermal management module 200, 202, 204 are used to maintain a temperature of the battery system 116 (see FIG. 5) within an acceptable operating temperature range. Specifically, three battery thermal management modules 200, 202, 204 are coupled with the work machine 100. The battery thermal management modules 200, 202, 204 are similar to each other in terms of design and functionality.

The battery thermal management module 200, 202, 204 may be disposed at the first side 106 of the work machine 100, the second side 108 of the work machine 100, and/or distal from the first side 106 of the work machine 100 and proximal to the second side 108 of the work machine 100. Specifically, the battery thermal management module 200 is disposed at the first side 106 of the work machine 100. The battery thermal management module 202 is disposed at the second side 108 of the work machine 100. The battery thermal management module 204 is disposed distal from the first side 106 of the work machine 100 and proximal to the second side 108 of the work machine 100. Specifically, the battery thermal management module 204 is disposed between the battery thermal management module 200 and the battery thermal management module 202. The battery thermal management module 204 is disposed within the enclosure 134.

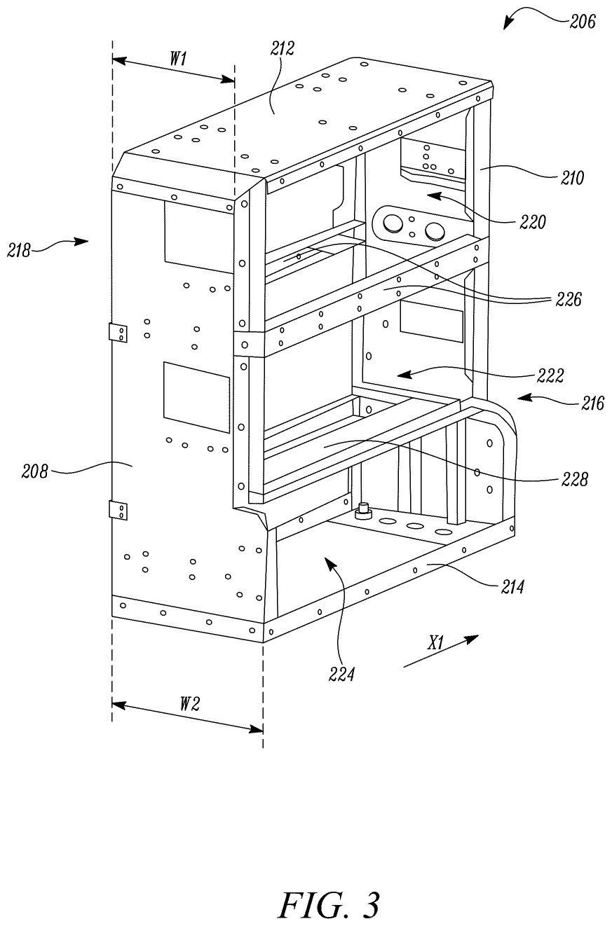

Referring now to FIG. 3, the battery thermal management module 200, 202, 204 includes a housing 206. The housing 206 includes a number of walls 208, 210, 212, 214. Specifically, the housing 206 includes a first side wall 208, a second side wall 210 disposed opposite the first side wall 208 along a first axis X1, a top wall 212 extending along the first axis X1 and connecting the first side wall 208 with the second side wall 210, and a bottom wall 214 disposed opposite the top wall 212 and connecting the first side wall 208 with the second side wall 210. The first side wall 208 and the second side wall 210 are substantially parallel to each other. The top wall 212 and the bottom wall 214 are substantially parallel to each other. The first side wall 208, the second side wall 210, the top wall 212, and the bottom wall 214 may be hereinafter interchangeably referred to as the walls 208, 210, 212, 214, respectively.

Further, the housing 206 defines a first end 216 and a second end 218. The second end 218 is opposite the first end 216. The number of walls 208, 210, 212, 214 define a first section 220, a second section 222, and a third section 224 of the housing 206. The second section 222 is disposed between the first section 220 and the third section 224. The first and second sections 220, 222 are divided by a pair of first horizontal members 226 disposed at the front and second ends 216, 218, respectively. The second section 222 is defined below the first section 220. Further, the third section 224 is defined below the second section 222. The second and third sections 222, 224 are divided by a second horizonal member 228. Furthermore, the first and second sections 220, 222 have a same width W1. Moreover, a width W2 of the third section 224 is greater than the width W1 of the first and second sections 220, 222.

The battery thermal management module 200, 202, 204 is removably coupled with the work machine 100 (see FIG. 1) via the housing 206. Specifically, the battery thermal management module 200, 202, 204 is removably coupled with the work machine 100, proximal to the front end 102 (see FIG. 1) of the work machine 100, via one or more of the first side wall 208, the second side wall 210, the top wall 212, and the bottom wall 214 of the housing 206.

The battery thermal management module 200, 202, 204 may include a number of mechanical fasteners (not shown) to removably couple one or more of the first side wall 208, the second side wall 210, the top wall 212, and the bottom wall 214 of the housing 206 with the work machine 100. The mechanical fasteners may include bolts, without any limitations.

As shown in FIG. 2, the battery thermal management module 200 is removably coupled with each of the trolley structure 136 of the work machine 100 via the second side wall 210, the first fender 138 of the work machine 100 disposed proximal to the first side 106 of the work machine 100 via the first side wall 208, and the operator platform 128 of the work machine 100 via the top wall 212. Specifically, the second side wall 210 is directly coupled with the trolley structure 136 at locations 246. At each location 246, two mechanical fasteners are used to couple the second side wall 210 with the trolley structure 136. Further, the housing 206 includes a pair of first mounting brackets (not shown herein) coupled with the first side wall 208. The first mounting brackets couple the housing 206 with the first fender 138. Further, each first mounting bracket is coupled with the first fender 138 via two mechanical fasteners. Moreover, the housing 206 includes a first mounting structure 250 coupled with the top wall 212. The first mounting structure 250 removably couples the top wall 212 with the operator platform 128 (see FIG. 1) of the work machine 100. The first mounting structure 250 is coupled with the operator platform 128 via two mechanical fasteners.

Further, the battery thermal management module 202 is removably coupled with each of the trolley structure 136 of the work machine 100 via the first side wall 208, the second fender 140 of the work machine 100 disposed proximal to the second side 108 of the work machine 100 via the second side wall 210, and the operator platform 128 of the work machine 100 via the top wall 212. Specifically, the first side wall 208 is directly coupled with the trolley structure 136 at two locations (not shown herein). At each location, two mechanical fasteners are used to couple the first side wall 208 with the trolley structure 136. Further, the housing 206 includes a pair of second mounting brackets 252 coupled with the second side wall 210. The second mounting brackets 252 are same as the first mounting brackets coupled to the first side wall 208 of the battery thermal management module 200. The second mounting brackets 252 couple the battery thermal management module 202 with the second fender 140. Further, each second mounting bracket 252 is coupled with the second side wall 210 via two mechanical fasteners.

Moreover, the housing 206 includes a second mounting structure 254 coupled with the top wall 212. The second mounting structure 254 removably couples the top wall 212 with the operator platform 128 of the work machine 100. The second mounting structure 254 is coupled with the operator platform 128 via two mechanical fasteners.

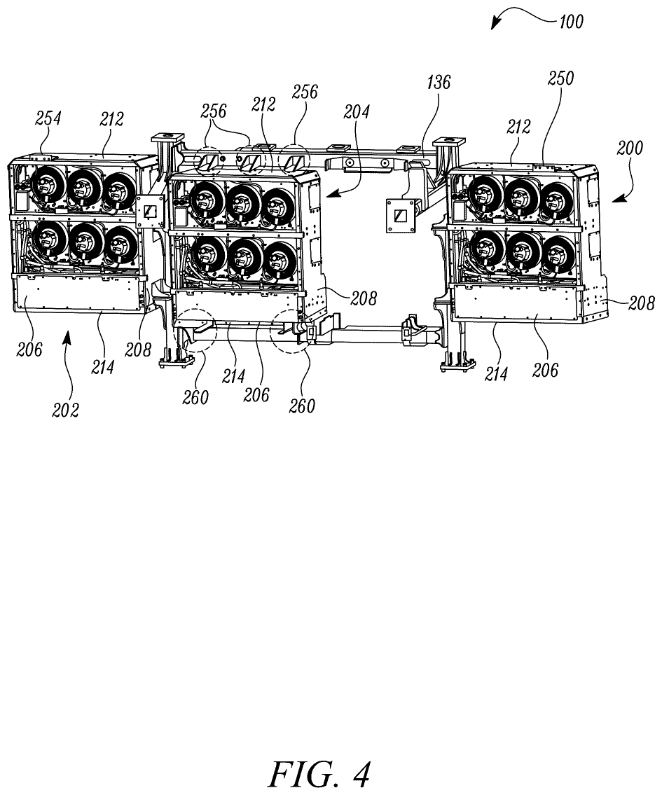

As shown in FIG. 4, the battery thermal management module 204 is removably coupled with the trolley structure 136 of the work machine 100 via each of the top wall 212 and the bottom wall 214. Specifically, the top wall 212 is directly coupled with the trolley structure 136 at two locations 256. At each location 256, two mechanical fasteners are used to couple the top wall 212 with the trolley structure 136. Moreover, the bottom wall 214 is directly coupled with the trolley structure 136 at two locations 260. At each location 260, two mechanical fasteners are used to couple the bottom wall 214 with the trolley structure 136. It should be noted that the battery thermal management module 202, 204, 206 or the work machine 100 may include any number of intermediate components/elements, without any limitations, to facilitate coupling between the battery thermal management module 202, 204, 206 and the work machine 100.

As shown in FIG. 5, the battery thermal management module 200, 202, 204 also includes a cooling assembly 264 disposed within the housing 206. The cooling assembly 264 supplies a coolant to the battery system 116 associated with the work machine 100 (see FIG. 1). The cooling assembly 264 includes a first condenser module 266 disposed in the first section 220 of the housing 206. The cooling assembly 264 includes a second condenser module 268 disposed in the second section 222 of the housing 206. Each of the first condenser module 266 and the second condenser module 268 includes a number of fan assemblies 292. Specifically, the first condenser module 266 includes three fan assemblies 292 and the second condenser module 268 includes three fan assemblies 292.

The battery thermal management module 200, 202, 204 also includes an electric junction box 294 disposed in the first section 220 and electrically coupled with each of the first condenser module 266, the second condenser module 268, and one or more chiller modules 270. Further, the battery thermal management module 200, 202, 204 includes a number of high voltage electrical connection cables 296 that electrically couple the electric junction box 294 with each of the first condenser module 266, the second condenser module 268, and the one or more chiller modules 270. The electric junction box 294 includes a high voltage interface 298 that connects the high voltage electrical connection cables 296 with the work machine 100. The battery thermal management module 200, 202, 204 also includes a number of low voltage electrical connection cables 300 that electrically couple the electric junction box 294 with each of the first condenser module 266, the second condenser module 268, and the one or more chiller modules 270. The electric junction box 294 includes a low voltage interface 302 that connects the low voltage electrical connection cables 300 with the work machine 100.

Further, the battery thermal management module 200, 202, 204 includes a first fluid inlet port 304 disposed in the second section 222 to supply a high temperature coolant towards the first condenser module 266. The first fluid inlet port 304 receives the high temperature coolant from the battery system 116. The battery thermal management module 200, 202, 204 also includes one or more first high coolant temperature lines (not shown herein) to fluidly couple the first fluid inlet port 304 with the first condenser module 266. The battery thermal management module 200, 202, 204 also includes a first fluid outlet port 308 disposed in the first section 220 to receive a low temperature coolant from the first condenser module 266. The first fluid outlet port 308 supplies the low temperature coolant to the battery system 116. The battery thermal management module 200, 202, 204 also includes one or more first low temperature coolant lines (not shown) to fluidly couple the first condenser module 266 with the first fluid outlet port 308.

Furthermore, the battery thermal management module 200, 202, 204 includes a second fluid inlet port 312 disposed in the second section 222 to supply a high temperature coolant towards the second condenser module 268. The second fluid inlet port 312 receives the high temperature coolant from the battery system 116. The battery thermal management module 200, 202, 204 also includes one or more second high coolant temperature lines (not shown) to fluidly couple the second fluid inlet port 312 with the second condenser module 268. The battery thermal management module 200, 202, 204 also includes a second fluid outlet port 316 disposed in the second section 222 to receive a low temperature coolant from the second condenser module 268. The second fluid outlet port 316 supplies the low temperature coolant to the battery system 116. The battery thermal management module 200, 202, 204 also includes one or more second low temperature coolant lines (not shown) to fluidly couple the second condenser module 268 with the second fluid outlet port 316.

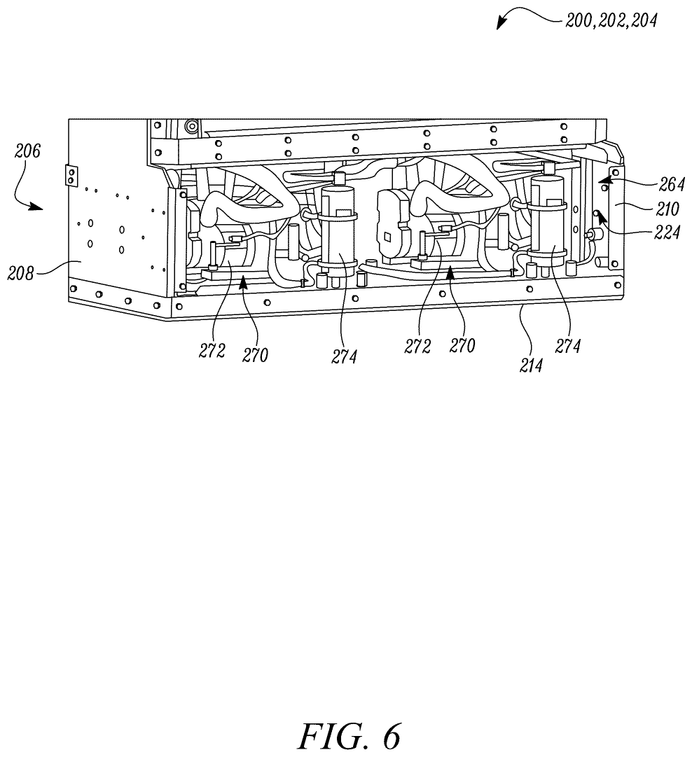

As shown in FIG. 6, the cooling assembly 264 includes the one or more chiller modules 270 disposed in the third section 224 of the housing 206. Specifically, the one or more chiller modules 270 includes a pair of chiller modules 270 that are disposed adjacent to each other. Each chiller module 270 includes, among other components, a compressor 272, an evaporator (not shown), and a dryer 274.

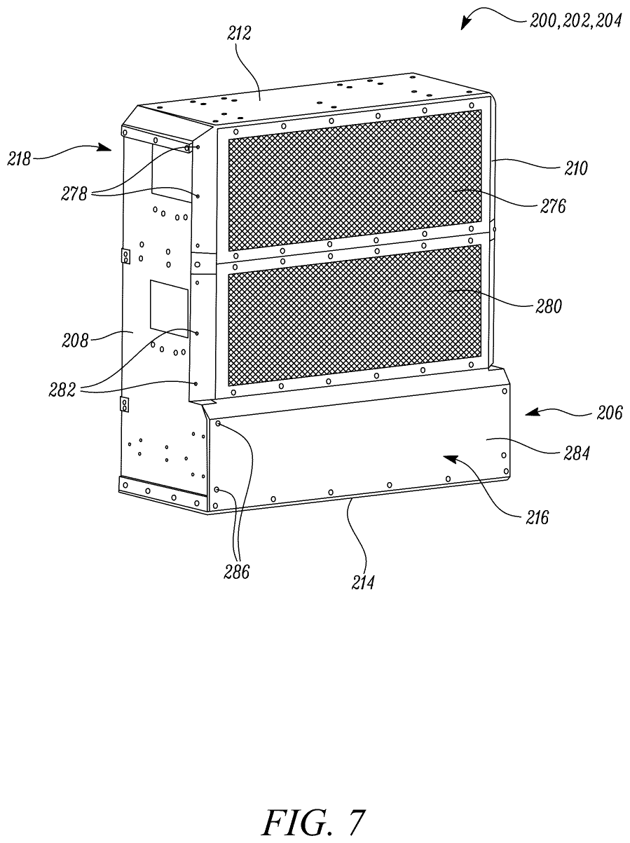

Referring now to FIG. 7, the battery thermal management module 200, 202, 204 includes a first cover 276 removably coupled with the housing 206 proximal to the first end 216 of the housing 206 to enclose the first section 220 (see FIG. 3) of the housing 206. The first cover 276 is removably coupled with the housing 206 via a number of first fasteners 278.

The battery thermal management module 200, 202, 204 also includes a second cover 280 removably coupled with the housing 206 proximal to the first end 216 of the housing 206 to enclose the second section 222 (see FIG. 3) of the housing 206. The second cover 280 is removably coupled with the housing 206 via a number of second fasteners 282. It should be noted that only the battery thermal management modules 200, 202 include the first and second covers 276, 280. The first and second covers 276, 280 are omitted from the battery thermal management module 204 as the battery thermal management module 204 is disposed adjacent to the grille 132 (see FIG. 1). Further, each of the first and second covers 276, 280 are embodied as grills having a number of openings therein.

The battery thermal management module 200, 202, 204 further includes a third cover 284 removably coupled with the housing 206 proximal to the first end 216 of the housing 206 to enclose the third section 224 (see FIG. 3) of the housing 206. The third cover 284 is removably coupled with the housing 206 via a number of third fasteners 286. Furthermore, the first, second, and third fasteners 278, 282, 286 may include bolts.

Referring again to FIG. 5, the battery thermal management module 200, 202, 204 also includes a fourth cover 288 removably coupled with the housing 206 proximal to the second end 218 of the housing 206 to enclose the third section 224 (see FIG. 3) of the housing 206. The fourth cover 288 is removably coupled with the housing 206 via a number of fourth fasteners 290. The fourth fasteners 290 may include bolts. It should be noted that each of the battery thermal management modules 200, 202, 204 includes the third and fourth covers 284, 288.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the battery thermal management module 200, 202, 204 for the work machine 100. Specifically, three battery thermal management modules 200, 202, 204 are coupled to the work machine 100. Further, a single part number of the battery thermal management module 200, 202, 204 can be mounted at three locations on the work machine 100. The battery thermal management modules 200, 202, 204 facilitate cooling of the battery system 116 of the work machine 100. The three battery thermal management modules 200, 202, 204 may together provide sufficient cooling to a large sized battery system 116 that may be associated with the work machine 100.

The battery thermal management modules 200, 202, 204 are disposed at the front end 102 of the work machine 100 without affecting an arrangement of other components of the work machine 100, while effectively utilizing a mounting space available on the work machine 100. The battery thermal management modules 200, 202, 204 have a compact design and accommodate the various components of the cooling assembly 264 within a lower footprint. The battery thermal management modules 200, 202, 204 may be retrofitted on existing work machines and have a modular design.

The battery thermal management modules 200, 202, 204 described herein have an aesthetic design. Further, a design of the battery thermal management modules 200, 202, 204 may reduce time and efforts required to access, service, and/or replace one or more components of the cooling assembly 264. For example, when a component of the cooling assembly 264 is to be serviced, one or more of the first, second, third, and/or fourth covers 276, 280, 284, 288 may be removed to provide easy and quick access to the cooling assembly 264 for servicing and maintenance, without requiring disassembly of the entire battery thermal management modules 200, 202, 204. Further, each of the first condenser module 266, the second condenser module 268, and the chiller modules 270 can be individually removed and/or replaced from the housing 206, as per requirements. Furthermore, the battery thermal management modules 200, 202, 204 can be easily coupled with the work machine 100 in a time-effective manner using the mechanical fasteners.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A battery thermal management module for a work machine, the battery thermal management module comprising:
a housing including a first side wall, a second side wall disposed opposite the first side wall along a first axis, a top wall extending along the first axis and connecting the first side wall with the second side wall, and a bottom wall disposed opposite the top wall and connecting the first side wall with the second side wall, wherein the battery thermal management module is adapted to be removably coupled with the work machine, proximal to a front end of the work machine, via at least one of the first side wall, the second side wall, the top wall, and the bottom wall of the housing; and
a cooling assembly disposed within the housing, wherein the cooling assembly is adapted to supply a coolant to a battery system associated with the work machine.

2. The battery thermal management module of claim 1, wherein the battery thermal management module is adapted to be disposed at a first side of the work machine, and wherein the battery thermal management module is adapted to be removably coupled with each of a trolley structure of the work machine via the second side wall, a first fender of the work machine disposed proximal to the first side of the work machine via the first side wall, and an operator platform of the work machine via the top wall.

3. The battery thermal management module of claim 2, wherein the housing further includes a first mounting structure coupled with the top wall, and wherein the first mounting structure is adapted to removably couple the top wall with the operator platform of the work machine.

4. The battery thermal management module of claim 2, wherein the battery thermal management module is adapted to be disposed at a second side of the work machine, wherein the second side is opposite the first side, and wherein the battery thermal management module is adapted to be removably coupled with each of the trolley structure of the work machine via the first side wall, a second fender of the work machine disposed proximal to the second side of the work machine via the second side wall, and the operator platform of the work machine via the top wall.

5. The battery thermal management module of claim 4, wherein the housing further includes a second mounting structure coupled with the top wall, and wherein the second mounting structure is adapted to removably couple the top wall with the operator platform of the work machine.

6. The battery thermal management module of claim 4, wherein the battery thermal management module is adapted to be disposed distal from the first side of the work machine and proximal to the second side of the work machine, and wherein the battery thermal management module is adapted to be removably coupled with the trolley structure of the work machine via each of the top wall and the bottom wall.

7. A battery thermal management module for a work machine, the battery thermal management module comprising:
a housing including a plurality of walls, the plurality of walls define a first section, a second section, and a third section of the housing, wherein the battery thermal management module is adapted to be removably coupled with the work machine via the housing; and
a cooling assembly disposed within the housing, wherein the cooling assembly is adapted to supply a coolant to a battery system associated with the work machine, the cooling assembly including:
a first condenser module disposed in the first section of the housing;
a second condenser module disposed in the second section of the housing; and
at least one chiller module disposed in the third section of the housing.

8. The battery thermal management module of claim 7, wherein the second section is disposed between the first section and the third section.

9. The battery thermal management module of claim 7, wherein the at least one chiller module includes a pair of chiller modules that are disposed adjacent to each other.

10. The battery thermal management module of claim 7 further comprising a first cover removably coupled with the housing proximal to a first end of the housing to enclose the first section of the housing.

11. The battery thermal management module of claim 10 further comprising a second cover removably coupled with the housing proximal to the first end of the housing to enclose the second section of the housing.

12. The battery thermal management module of claim 10 further comprising a third cover removably coupled with the housing proximal to the first end of the housing to enclose the third section of the housing.

13. The battery thermal management module of claim 12 further comprising a fourth cover removably coupled with the housing proximal to a second end of the housing to enclose the third section of the housing, wherein the second end is opposite the first end.

14. The battery thermal management module of claim 7 further comprising an electric junction box disposed in the first section and electrically coupled with each of the first condenser module, the second condenser module, and the at least one chiller module.

15. The battery thermal management module of claim 14 further comprising:
a plurality of high voltage electrical connection cables that electrically couple the electric junction box with each of the first condenser module, the second condenser module, and the at least one chiller module; and
a plurality of low voltage electrical connection cables that electrically couple the electric junction box with each of the first condenser module, the second condenser module, and the at least one chiller module.

16. The battery thermal management module of claim 7 further comprising:
a first fluid inlet port disposed in the second section to supply a high temperature coolant towards the first condenser module; and
a first fluid outlet port disposed in the first section to receive a low temperature coolant from the first condenser module.

17. The battery thermal management module of claim 7 further comprising:
a second fluid inlet port disposed in the second section to supply a high temperature coolant towards the second condenser module; and
a second fluid outlet port disposed in the second section to receive a low temperature coolant from the second condenser module.

18. The battery thermal management module of claim 7, wherein each of the first condenser module and the second condenser module includes a plurality of fan assemblies.

19. The battery thermal management module of claim 7, wherein the battery thermal management module is adapted to be removably coupled with the work machine proximal to a front end of the work machine.

20. The battery thermal management module of claim 7, wherein the battery thermal management module is adapted to be disposed at a first side of the work machine, a second side of the work machine, and/or distal from the first side of the work machine and proximal to the second side of the work machine, and wherein the second side is opposite the first side.
